(19) United States
(12) Patent Application Publication
(10) Pub. No.: US 2025/0020496 A1
(43) Pub. Date: Jan. 16, 2025

(54) MULTIDIMENSIONAL CAPACITANCE MULTIPHASE FLOW METER

(71) Applicant: Tech4Imaging LLC, Columbus, OH (US)

(72) Inventors: Qussai Marashdeh, Columbus, OH (US); Benjamin Straiton, Hilliard, OH (US); Matthew Charleston, Westerville, OH (US)

(21) Appl. No.: 18/590,693

(22) Filed: Feb. 28, 2024

Related U.S. Application Data
(60) Provisional application No. 63/526,119, filed on Jul. 11, 2023.

(51) Int. Cl. G01F 1/58; G01F 1/74

(52) U.S. Cl. CPC G01F 1/584; G01F 1/74

(57) ABSTRACT

A non-intrusive multi-dimensional or multi-phase flow measurement instrument that uses capacitance electrodes to measure volume fraction (0-100%) and velocity for flows having single or multiple phases. It includes integrating the multi-dimensional capacitance sensing technology with several algorithms to increase accuracy and detect fluid phases and flow conditions. The multi-dimensional flow meter is a universal instrument to measure flows with single, two, three, or more phases using a set of multi-dimensional capacitance sensors. The multi-dimensional flow meter is capable of measuring the individual components and flow rates of virtually any multi-phase flow by using single amplitude and electric phase measurements or integrating multiple measurements of amplitude, phase (and at different frequencies), to identify the volumetric or mass flow rate of a passing flow.

### CROSS-REFERENCE TO RELATED APPLICATIONS

This application claims priority to provisional patent application U.S. Application No. 63/526,119 filed on Jul. 11, 2023 and is herein incorporated by reference in its entirety.

### BACKGROUND OF THE INVENTIVE FIELD

Most flow meter technologies operate in single-phase flows only and cannot handle changing fluid conditions, density, viscosity, air bubbles, etc. without losing accuracy. Most existing multi-dimensional flow meters use combinations and correlations of existing single-phase technologies and do not perform well over the full range (0-100%) of volume fractions.

This present invention relates to a non-intrusive multi-dimensional and multi-phase flow measurement instrument that uses the same capacitance electrodes to measure volume fraction (0-100%) and velocity for flows having single or multiple flow phases. It also provides an alternative approach of measuring single and multiple flow phases by using capacitance electrodes to measure volume fraction (0-100%) and at least one thermal flow sensor, in combination with the capacitance sensor, to measure mass flow. It includes integrating the multi-dimensional capacitance sensing technology with several methods of collecting and processing data or algorithms to increase accuracy and detect fluid phases and flow conditions. Multi-dimensional generally refers to measuring the phase, amplitude, and any of their derivatives and at different frequencies. The present invention relates to embodiments for measuring the electric phase, amplitude, derivatives, and at different frequencies whether using all those together, or by themselves. Multi-phase relates to the function or state of the flow (e.g., solid, gas, liquid, etc.), whereas multi-dimensional is a function of the electric signal measured. For example, to measure a flow of gas-solid or oil-water, the current system can use the amplitude of the measured signal as a representation of volume fraction. It can also use the electric phase of the measured signal to determine the volume fraction. Those measurements can also be performed at different frequencies.

In one embodiment, the present invention preferably provides a universal instrument to measure flows with single, two, three, or more phases using the same set of multi-dimensional capacitance sensors. The multi-dimensional approach involves activating the capacitance sender plate sensor with a sinusoidal excitation that can be of a single or multiple frequencies and detecting a signal amplitude, phase, or both from a receiving plate. In its simplest form, the sender plate may be excited with a single frequency excitation signal and the receiver plate records the receiver signal amplitude or phase.

In one embodiment, the present invention is capable of measuring the individual components and flow rates of virtually any multi-phase flow by using a single amplitude and electric phase measurement or integrating multiple measurements of amplitude, phase, and at different frequencies, to identify the volumetric or mass flow rate of a passing flow.

The volumetric flow rate is preferably measured by multiplying the volume fraction as measured from the amplitude, phase, or both by the velocity of the flow phases. The velocity is measured by correlating the amplitude or phase of different receiver plates in the same sensor. The multi-dimensional sensor preferably provides both volume fraction and velocity measurements without the need for auxiliary sensors.

The present invention is also able to measure mass flow rates of single-phases of a multi-phase flow by multiplying the volumetric flow rate of each phase by its density. The present invention also allows for adjusting densities based on flow temperatures.

The present invention allows for sensor plates to be of circular shape to reduce singularities and improve electric field distribution. It also allows for using multiple sensors for better distribution of electric field.

The present invention also allows for various plate geometries to distribute or focus the electric field.

The present invention also allows for multiple layers of electrodes in the sensor to measure velocity by cross-correlations. The resolution of measured velocity can be set by the sensor based on distance between layers. The presence of multiple layers allows for different velocity resolutions.

The present invention also allows for ratio-metric measurements between plates of different geometries. For example, the ratio of opposite plates measurements to adjacent plate measurements informs of the ratio of flow closer or further away from the pipe or conduit inner surface.

The present invention also allows for velocity correlation between different plate layers for flow velocity through the pipe and for correlations between plates within the same plate layer for velocities in the cross-section of the pipe or conduit.

The present invention also allows for calculating the slip velocity between different phases of the flow by measuring the velocity of each phase of the flow using the multi-dimensional sensing approach and correlations of measured signals.

The present invention also allows for determining the flow when it enters in the single-phase mode and allows for measuring the single-phase volumetric and mass flow rate by measuring the velocity using auxiliary sensors or by introducing disturbances in the flow.

In one embodiment, the present invention is comprised of a multi-dimensional capacitance sensor and a thermal sensor. The thermal sensor is capable of measuring the mass flow rate of a single-phase by measuring the heat dissipated from the thermal sensor as the flow passes. More heat dissipation is indicative of higher mass flow rates. In the multi-phase scenarios, the multi-dimensional capacitance sensor preferably measures the volume fraction of the phases. The measured volume fraction is then used to weight the thermal mass flow measurement to compensate for deviation from the single-phase measurement. The combined multi-dimensional capacitance sensor and thermal flow sensors provide the ability to measure the mass flow of single and multi-phase flows without the need to measure the flow velocity independently.

### SUMMARY OF THE GENERAL INVENTIVE CONCEPT

Multi-dimensional capacitance sensing is a technology that senses measured capacitances between sensor plates to collect information about each phase in a multi-phase flow system. It has provided insights into multi-phase flow phenomena in many industrial processes often in a combination of gas, liquid, and solid states, including cryogenic gas-liquid flows, pneumatic conveying, gravity drop flows, oil pipe lines, geothermal fluid flow, fluidized beds, bubble columns and many other chemical and biochemical processes. It may also be used for measuring flows in biological processes. See U.S. Pat. Nos. 8,614,707, 10,269,171, 10,806,366 and 10,705,043, and U.S. Patent Publication 2018/0325414 incorporated by reference herein. In the preferred embodiment of the invention, the present invention utilizes a multi-dimensional Data Acquisition System (DAS) technology for the electronics, and ECVT and/or adaptive ECVT for plate formation. The ECVT sensor distributes the electric field in 3D, which could be used in the present invention to place plates in a way that provide accurate volume fraction.

Multi-dimensional DAS technology was previously developed to measure capacitance between plates of a capacitance sensor based on excitation of the sender electrodes with sinusoidal signals of different frequencies. The measured signal amplitude and/or phase is then used to calculate the volume fraction of flow phases.

The present invention provides an innovative design for calculating the volumetric flow rate of each phases using the same sensor used for measuring the volume fraction. The velocity is measured by cross-correlating measurements of the sensor in multiple layers (e.g., layers of plates). The distance between layers in the sensor determine the velocity resolution. The sensor also preferably provides correlation signals from plates in the same layer for cross-sectional flow velocities.

This is cross-correlation (e.g., correlation) as discussed herein relates to an operation that measures similarity between two signals. When the flow passes through a first sensor plate pair and then passes through another sensor plate pair, the signal from both pairs will be similar but occurring at different times. The correlation measures when the maximum similarity happens in time. This time of maximum similarity is used to calculate velocity. For example, to track an object or flow, it could be passed through a first set of capacitance plates and then the flow moves to another set of plates. The time the object takes to arrive at the second set of plates coincides when the second set of plates provides a signal that is most similar to the signal from the first set of plates. The time it takes for this similarity to happen along with the distance between the two sets of plates may be used to calculate the object or flow velocity.

With the ability of measuring velocities of flow phases, slip velocities can also be calculated from the difference between velocities of measured flow phases. Those calculations are verified by total mass flow rate of the mixed flow.

The design of the current invention also preferably includes circular plates to better homogonies the electric field for better volume fraction measurements.

The interactive design of the present invention also preferably includes a temperature sensing mechanism for applications that involve wide variations in flow temperature. For example, a temperature sensor is established to adjust flow components densities for accurate estimation of mass flow rates.

The interactive design of the present invention includes identifying the flow regime by comparing measurements from different plate combinations. Flow regime relates to distribution styles of the flow. More specifically, it includes bubbly flow, stratified, stratified-wavy, plug, slug, annular, intermittent, mist flow, and turbulent flow.

The present invention includes measuring the mass flow rate of single or multi-phase flows without directly measuring the velocity. This is achieved by using a thermal mass flow meter (e.g., using thermal sensor(s)) to measure an initial reading of mass flow and correcting the reading based on the measured volume fraction of phases from the multi-dimensional capacitance sensor.

In one embodiment of the invention, the invention is comprised of: a capacitance sensor having a plurality of plates, a data acquisition circuit in communication with the capacitance sensor, wherein the data acquisition circuit receives input data from the capacitance sensor including current output from the capacitance sensor, one or more processors operationally connected to the data acquisition circuit, wherein the one or more processors receive a signal from the data acquisition circuit and wherein the one more processors are configured to extract amplitude or phase data from the signal, a thermal sensor operationally connected to the data acquisition circuit, a non-transitory computer-readable medium including one or more sequences of instructions that, when executed by the one or more processors, cause the one or more processors to obtain a mass flow rate of a single-phase flow based on information received from the thermal sensor.

In one embodiment, the capacitance flow meter is adapted to detect a flow regime of a multi-phase flow by analyzing a time series signal of volume fraction, a volume fraction range, a symmetry in the time series signal, and a frequency analysis. The capacitance flow meter is preferably adapted to detect the flow regime of the multi-phase flow by a comparison of signals between sets of plates of the capacitance sensor or an analysis of a flow velocity.

The non-transitory computer-readable medium preferably includes one or more sequences of instructions that, when executed by one or more processors, cause the one or more processors to perform a spectroscopy sweep of the multi-phase flow; and wherein the sweep is performed by exciting the plates with an excitation signal frequency sweep to record a response over a frequency sweep range.

The capacitance flow meter in combination with the thermal sensor provides the ability to measure the mass flow rate in both single and multi-phase flow regimes. The capacitance flow meter of claim 13, is preferably comprised of a thermal sensor that uses two thermometers along the direction of the single-phase flow, wherein heat is injected after a first thermometer and before a second thermometer, and wherein a difference in temperature between the first and second thermometers is used to calculate the mass flow rate of the single-phase flow. The thermometers can also be in the same plane, where one thermometer acts as a reference and the other records the deviation in measured temperature from the first reference thermometer.

In one embodiment of the capacitance flow meter, the non-transitory computer-readable medium includes one or more sequences of instructions that, when executed by one or more processors, cause the one or more processors to determine a mass flow rate of a multi-phase flow when signals from the thermal sensor are compensated with a volume fraction of each phase. The thermal sensor is adapted to be wrapped around a pipe or column or placed on a spot on a surface of a conduit through which the flow is conveyed.

The foregoing and other features and advantages of the present invention will be apparent from the following more detailed description of the particular embodiments, as illustrated in the accompanying drawings.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates one embodiment of the multi-dimensional flow meter of the present invention;

FIG. 2 illustrates the operation of one embodiment of the multi-dimensional flow meter from a one dimensional measurement of capacitance magnitude;

FIG. 3 illustrates the operation of another embodiment of the multi-dimensional flow meter from a one dimensional measurement of capacitance magnitude;

FIG. 4 illustrates the operation of another embodiment of the multi-dimensional flow meter from a one dimensional measurement of capacitance magnitude;

FIG. 5 illustrates the operation of one embodiment the multi-dimensional flow meter from a multi-dimensional measurement of capacitance magnitude and phase;

FIG. 6 illustrates the operation of one embodiment of the multi-dimensional flow meter from the multi-dimension measurement of capacitance magnitude and phase at different frequencies;

FIG. 7 illustrates the operation of one embodiment of an eight-plate sensor with circular plates;

FIG. 8 illustrates one embodiment of an eight-plate multi-dimensional flow meter (having a sensor with circular plates) in combination with a thermal single-phase system or flow meter for measurement of the mass flow rate of combined single and multi-phase phase flow;

FIG. 9 illustrates different flow regimes passing vertically;

FIG. 10 illustrates different flow regimes passing horizontally;

FIG. 11 illustrates one embodiment of the invention having a combined capacitance and thermal sensor operating together; and

FIG. 12 illustrates a functional block diagram of one embodiment of the invention having combined capacitance and thermal sensors.

### DETAILED DESCRIPTION OF EXEMPLARY EMBODIMENTS

The following detailed description of the example embodiments refers to the accompanying figures that form a part thereof. The detailed description provides explanations by way of exemplary embodiments. It is to be understood that other embodiments may be used having mechanical and electrical changes that incorporate the scope of the present invention without departing from the spirit of the invention.

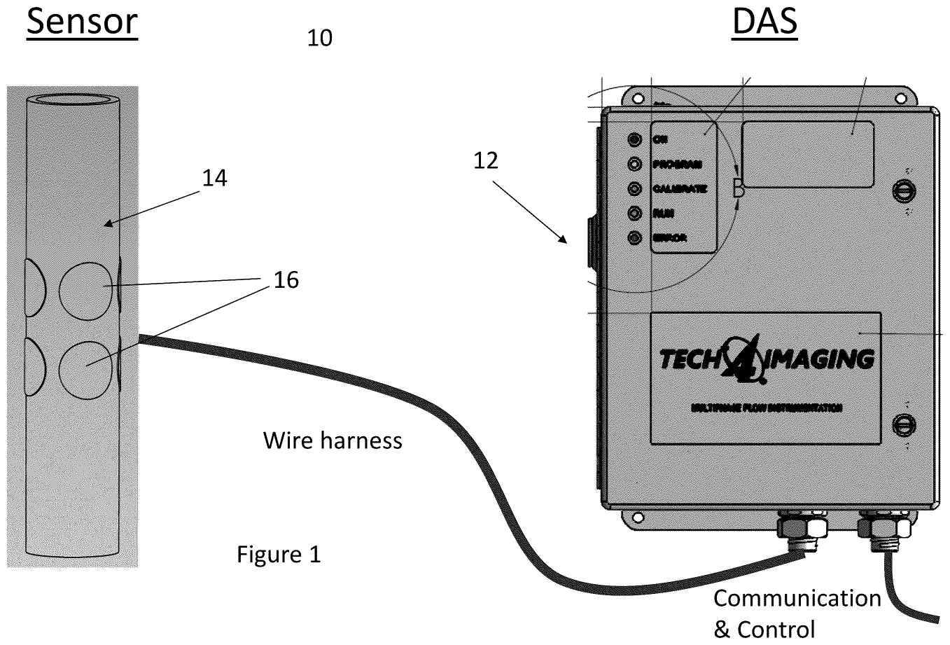

FIG. 1 depicts a multi-dimensional flow meter 10 composed of the Data Acquisition System (DAS) or circuit 12 and its enclosure, a sensor 14, a wire harness connecting the DAS to the sensor and communication and control wiring. The present invention relates to a multi-dimensional flow metering system that can operate in various flow regimes composed of single, two, or more flow phases. In the preferred embodiment, multi-dimensional activation of the data acquisition system allows for the measurement of volumetric or mass flow rates of each phase in a multi-phase flow system. This is achieved through a unique design and set of features explained below.

In the preferred embodiment, the DAS is adapted to excite a sender electrode with a sinusoidal signal at a given frequency. The sender electrode emits an electric field that is received by the receiving electrode. The DAS connects also to the receiving electrode where that received signal passes an electric current. The DAS converts this electric current into a voltage signal through an operational amplifier. It then passes the signal through gain amplifiers and through an analog-to-digital converter (ADC). The digital signal is then processed by processing system (like FPGA or a microcontroller) to condition it through demodulation and filtering so it can be transmitted as a signal indicative of volume fraction of the flow. The processing unit also performs cross-correlation or Fast Fourier Transform (FFT) operations on the volume fraction signal to measure velocity.

With respect to the embodiments of the present invention having a combination of capacitance and thermal sensors, the DAS is equipped with a port to drive a heater for the thermal sensing system, and at least two temperature sensors as inputs to the DAS. The DAS would subject the signals from the thermal sensors to gain an ADC and then perform a differential measurement using the processing unit. The differential measurement is indicative of a mass flow rate.

The present invention combines the thermal sensor with the capacitance sensor for measuring single-phase mass flow and for using the capacitance measurements to compensate for changes in the volume fraction of the flow so the thermal sensor can measure the mass flow of a multi-phase system.

In the preferred embodiment, for the capacitance measurement, the input is the current from the receiver electrodes and the processor works on a digital signal after it is conditioned and passed to an ADC. The processor can extract the amplitude or phase from this signal and at any given frequency. It also performs Fast Fourier Transform (FFT) calculation to measure velocity. When a thermal sensor is also included, a current signal from the thermal sensor is also inputted to the DAS. The processor works on those signals after they are converted digitally to conduct a differential measurement that is indicative of mass flow rate.

The left column illustrates a capacitance sensor with circular plates 16. The right column illustrates a DAS with a wire harness connected to the sensor and a control/communication wiring connected to a control system.

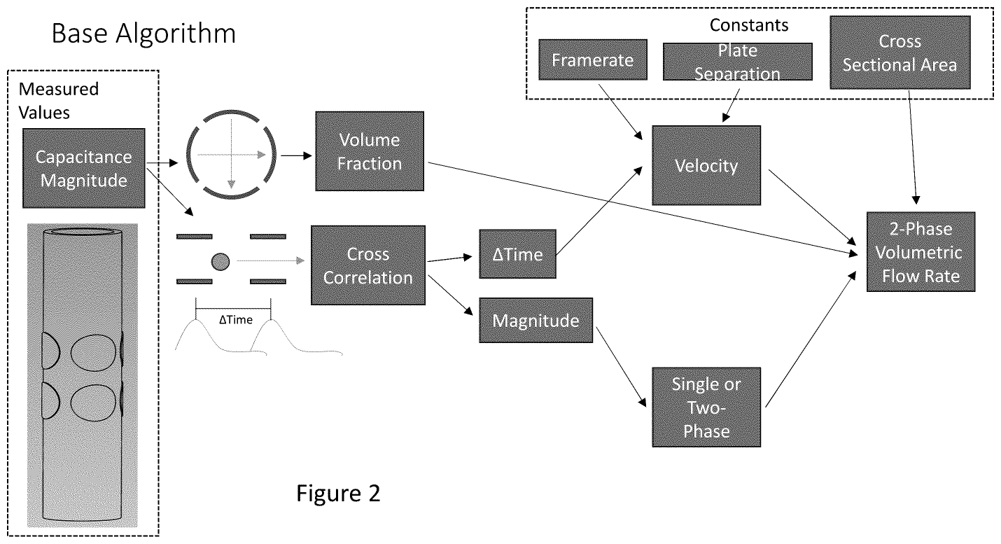

FIG. 2 illustrates the operation of one embodiment of the multi-dimensional flow meter from a one dimensional measurement of capacitance magnitude. In this embodiment, a sensor of four plates is used to measure the capacitance magnitude. The capacitance magnitude carries the volume fraction information. Correlation between signals from different plate pairs carries the velocity of the flow. The measured values with constants of plate separation, frame rate, and plate cross-sectional area provide the volumetric flow rate of a two-phase flow.

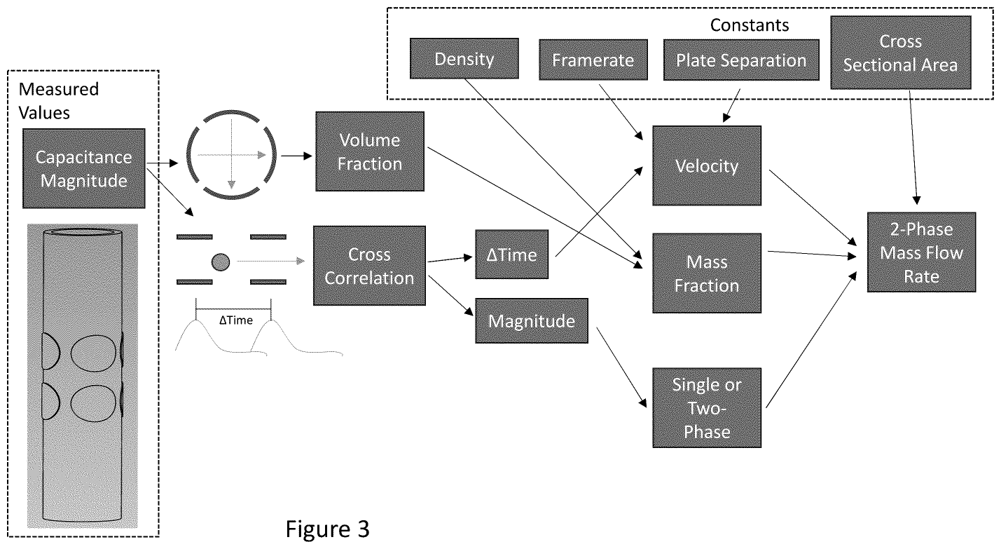

FIG. 3 illustrates the operation of another embodiment of the multi-dimensional flow meter from a one dimensional measurement of capacitance magnitude. In this embodiment, a sensor of four plates is used to measure the capacitance magnitude. The capacitance magnitude carries the volume fraction information. Density information is used to convert the volume fraction measurement into a mass measurement. Correlations between signals from different plate pairs carries the velocity of the flow. The measured values with constants of plate separation, frame rate, and plate cross-sectional area provide the mass flow rate of a two-phase flow.

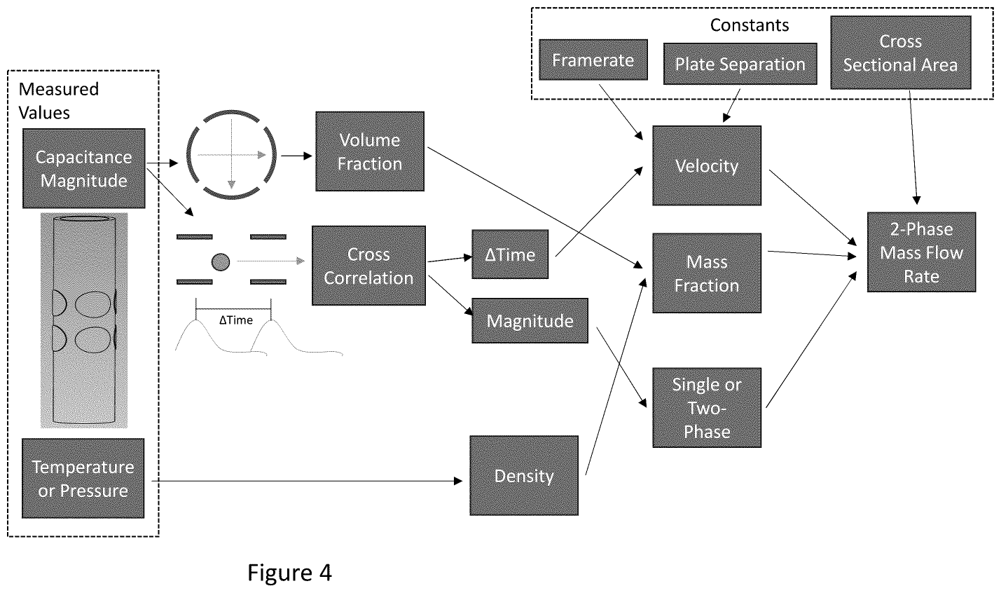

FIG. 4 illustrates the operation of another embodiment of the multi-dimensional flow meter from a one dimensional measurement of capacitance magnitude. In this embodiment, a sensor of four plates is used to measure the capacitance magnitude. The capacitance magnitude carries the volume fraction information. Density information is used to convert the volume fraction measurement into a mass measurement. Correlations between signals from different plate pairs carries the velocity of the flow. The measured values with constants of plate separation, frame rate, and plate cross-sectional area provide the mass flow rate of a two-phase flow. A temperature and/or pressure sensor are used to adjust the density of flow material in the calculation of the mass flow.

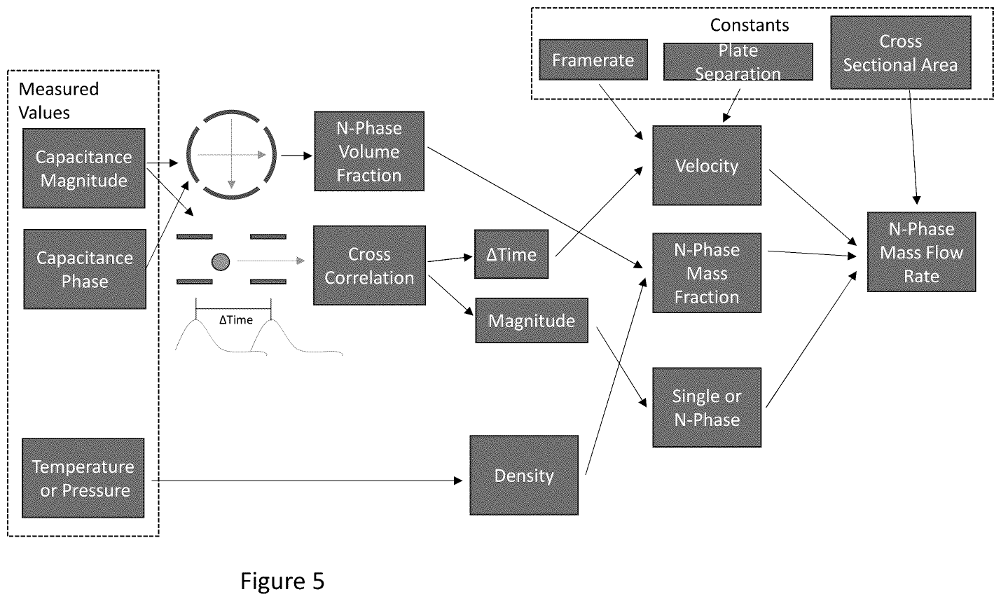

FIG. 5 illustrates the operation of one embodiment of the multi-dimensional flow meter from a multi-dimensional measurement of capacitance magnitude and phase. In this embodiment, a sensor of four plates is used to measure the capacitance magnitude. The capacitance magnitude and signal phase carry the volume fraction information. Density information is used to convert the volume fraction measurement into a mass measurement. Correlations between signals from different plate pairs carries the velocity of the flow phases. The slip velocity is calculated as the difference between velocities of different phases. The measured values with constants of plate separation, frame rate, and plate cross-sectional area provide the mass flow rate of a multi-phase flow of two or more phases. A temperature and/or pressure sensor are used to adjust the density of flow material in the calculation of the mass flow.

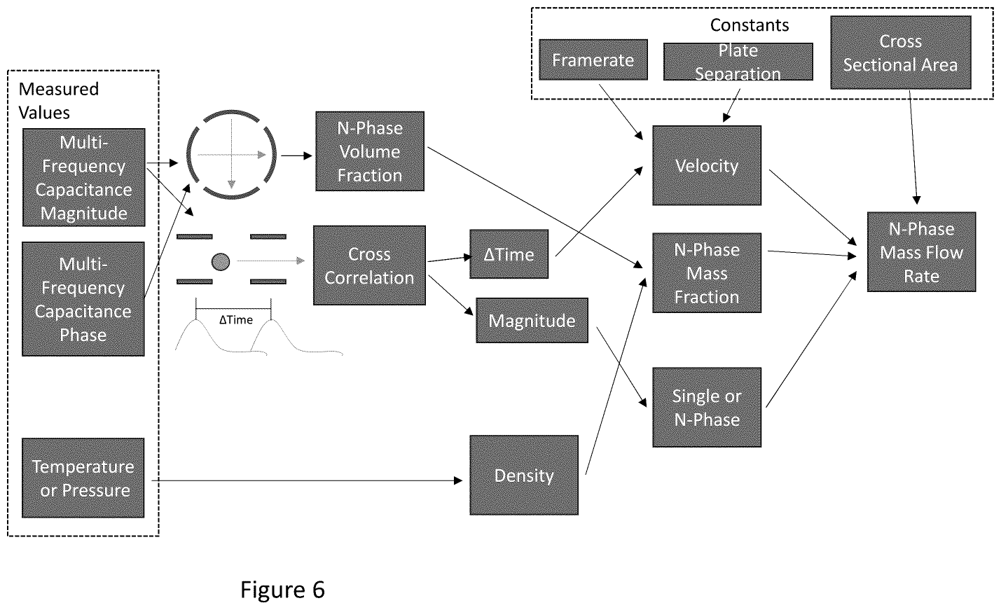

FIG. 6 illustrates the operation of one embodiment of the multi-dimensional flow meter from the multi-dimensional measurement of capacitance magnitude and phase at different frequencies. In this embodiment, a sensor of four plates is used to measure the capacitance magnitude. The capacitance magnitude and signal phase carry the volume fraction information. Density information is used to convert the volume fraction measurement into a mass measurement. Correlations between signals from different plate pairs carries the velocity of the flow phases. The slip velocity is calculated as the difference between velocities of different flow phases. The measured values with constants of plate separation, frame rate, and plate cross-sectional area provide the mass flow rate of a multi-phase flow of two or more phases. A temperature and/or pressure sensor are used to adjust the density of flow material in the calculation of the mass flow.

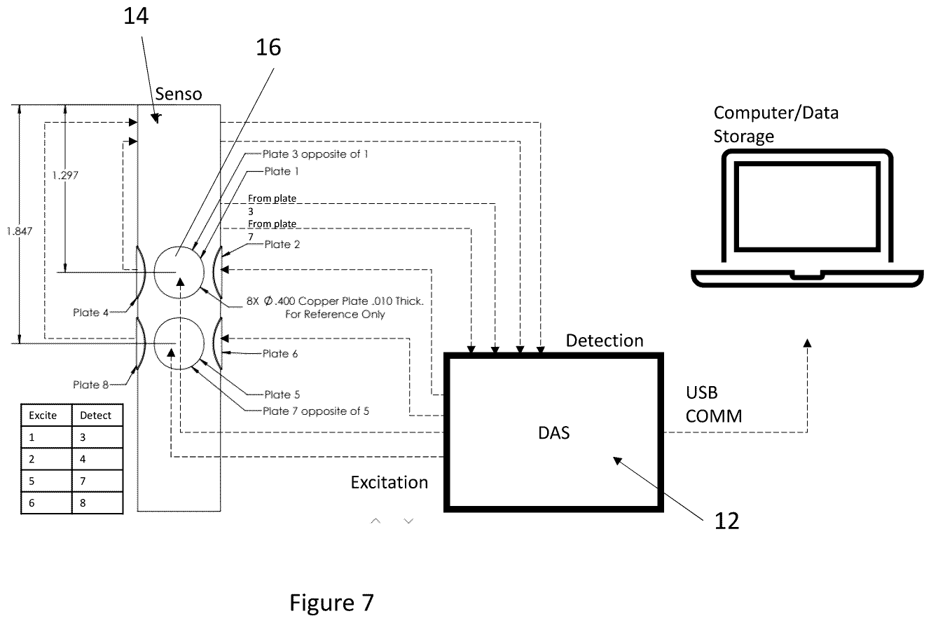

FIG. 7 illustrates the operation of one embodiment of an eight-plate sensor with circular plates. The plates are separated to either excite or detect. Opposite plate pairs are used for measurements to calculate volume fraction and flow velocity.

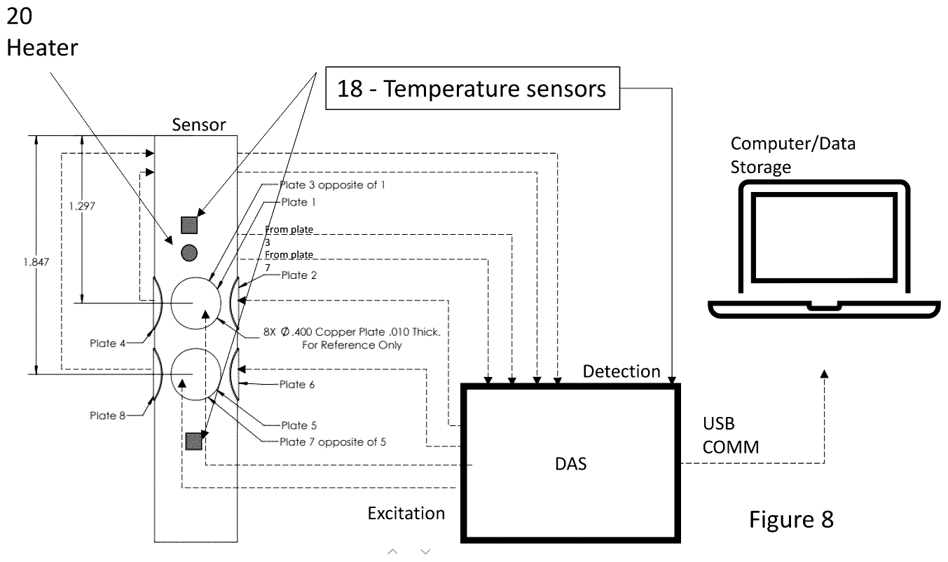

FIG. 8 illustrates one embodiment of an eight-plate multi-dimensional flow meter (having a sensor with circular plates) in combination with a thermal single-phase system or flow meter for measurement of the mass flow rate of combined single and multi-phase phase flow. The thermal system preferably measures the temperature at two different locations along the direction of the flow using temperature sensors 18 (e.g. thermometers). A heater 20 preferably introduces heat after the first temperature sensor. The difference in temperature of the two thermometers is used to calculate the mass flow rate of a single-phase of gas or liquid. As used herein, “signal phase” relates to a generally understood electric term for the measured signal phase (e.g., measurement of the phase and amplitude of currents and voltages) whereas the “flow phase” or “phase flow” refers to a generally understood term for the state of the flow (e.g., the gas, liquid, and solid component(s)).

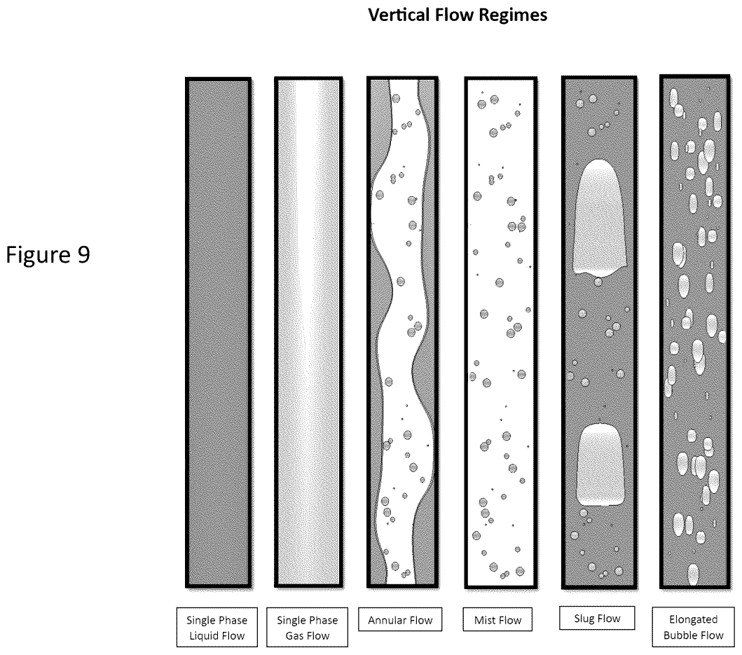

FIG. 9 illustrates one embodiment of flow regimes in the vertical direction. The multidimensional flow sensors are adapted to correctly identify each flow regime by measuring symmetry of the volume fraction measurements over time. The flow regimes illustrated (from left to right) are: single phase liquid flow, single phase gas flow, annular flow, mist flow, slug flow, and elongated bubble flow.

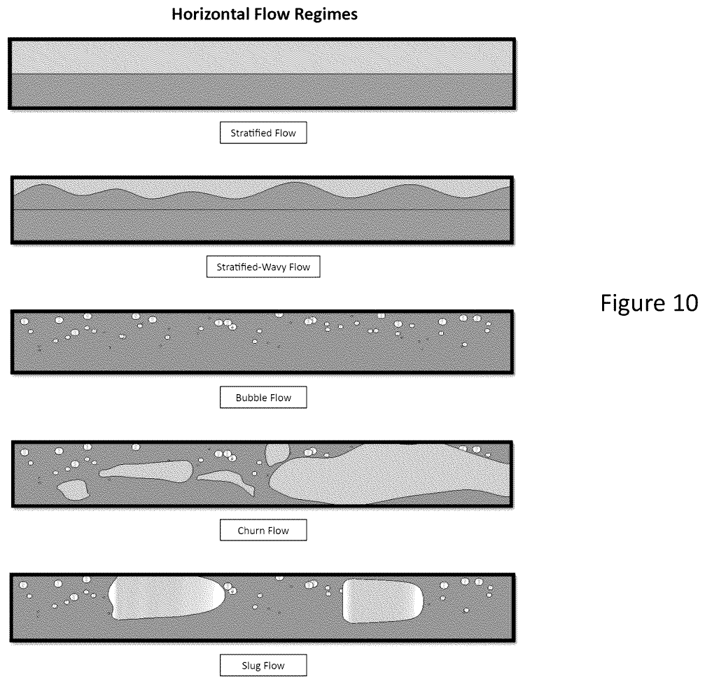

FIG. 10 illustrates one embodiment of flow regimes in the horizontal direction. The multidimensional flow sensors are able to correctly identify each flow regime by measuring symmetry of the volume fraction measurements over time. The flow regimes illustrated (from top to bottom) are: stratified flow, stratified-wavy flow, bubble flow, churn flow, and slug flow.

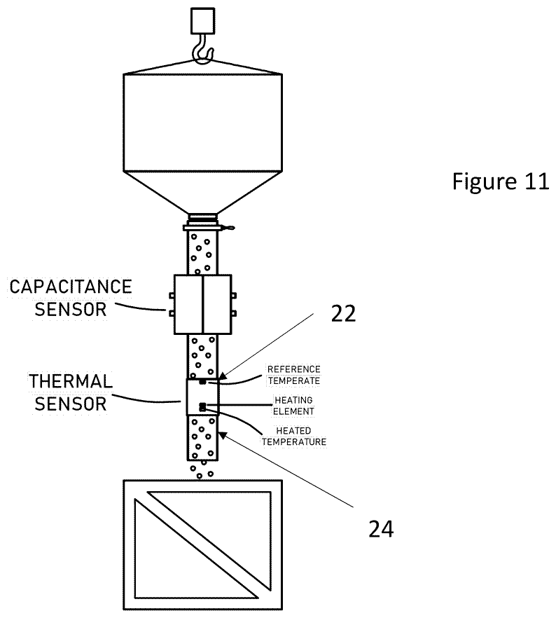

FIG. 11 illustrates one embodiment of the invention having a combined capacitance and thermal sensor operating together. The volume fraction of the flow is preferably measured by the capacitance sensor. A first thermometer 22 preferably measures the temperature of the flow before heat injection. A second thermometer 24 preferably measures the flow temperature after introducing heat into the flow. The differential measurement is used to calculate the mass flow rate. When the flow is multi-phase, the volume fraction measurement from the capacitance signal is used to weight the thermal flow sensors accordingly.

The thermometers can also be in the same plane (not necessarily in the direction of the flow), where one thermometer acts as a reference and the other records the deviation in measured temperature from the first reference thermometer. The thermal sensor can be both intrusive or non-intrusive.

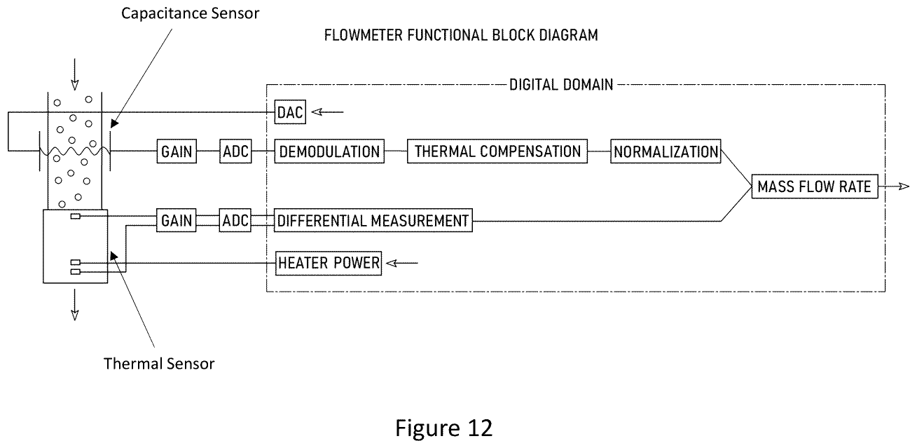

FIG. 12 illustrates a functional block diagram of one embodiment of the invention having combined capacitance and thermal sensors. The signal from the capacitance sensor is conditioned through gain amplifiers before passed through the ADC. The digital signal is then demodulated and thermally compensated to account for variation in the DAS and sensor ambient temperatures. The signal is then normalized to establish boundaries for the maximum and minimum volume fraction measurements. The thermal sensor signal is preferably collected from two temperature sensors (e.g. thermometers), one before the heat is introduced into the flow and one after. The signals are conditioned by gain and converted digitally through an ADC. The differential measurement from both sensors is used for mass flow measurement.

Although the aforementioned describes embodiments of the invention, the invention is not so restricted. It will be apparent to those skilled in the art that various modifications and variations can be made to the disclosed embodiments of the present invention without departing from the scope or spirit of the invention. Accordingly, these other sensors, plates data acquisition systems, thermal sensors, heaters, communication and control connections, and methods of operation are fully within the scope of the claimed invention. Therefore, it should be understood that the apparatuses and methods described herein are illustrative only and are not limiting upon the scope of the invention, which is indicated by the following claims.

What is claimed is:

1. A capacitance flow meter comprising:
a capacitance sensor having a plurality of plates, including at least one receiver plate and at least one excite plate,
a data acquisition circuit in communication with the capacitance sensor, wherein the data acquisition circuit receives input data from the capacitance sensor including current output from the capacitance sensor,
one or more processors operationally connected to the data acquisition circuit, wherein the one or more processors receive a signal from the data acquisition circuit and wherein the one or more processors are configured to extract amplitude or phase data from the signal,
a non-transitory computer-readable medium including one or more sequences of instructions that, when executed by one or more processors, cause the one or more processors to convert a measured capacitance into a volumetric flow rate for flows having single or multiple phases,
wherein a capacitance magnitude is used for a volume fraction estimation, and a correlation of signals between the plates in the sensor is used to determine a flow phase velocity estimation,
wherein the flow phase velocity is obtained by correlating capacitance magnitude or signal phase of signals received from different plates in the sensor, wherein correlation determines when the maximum similarity occurs between the signals, and
wherein the volumetric flow rate is a multiplication of the volume fraction estimation and the flow phase velocity.

2. A capacitance flow meter according to claim 1:
wherein the non-transitory computer-readable medium includes one or more sequences of instructions that, when executed by one or more processors, cause the one or more processors to convert the measured capacitance into a mass flow rate for flows having single or multiple phases using a flow density.

3. A capacitance flow meter according to claim 2, further comprising:
a temperature sensor to correct the flow density for mass flow measurement.

4. A capacitance flow meter comprising:
a capacitance sensor, having a plurality of plates, including at least one receiver plate and at least one excite plate,
a data acquisition circuit in communication with the capacitance sensor, wherein the data acquisition circuit receives input data from the capacitance sensor including current output from the capacitance sensor,
one or more processors operationally connected to the data acquisition circuit, wherein the one or more processors receive a signal from the data acquisition circuit and wherein the one more processors are configured to extract amplitude or phase data from the signal,
a non-transitory computer-readable medium including one or more sequences of instructions that, when executed by one or more processors, cause the one or more processors to convert at least one of a measured capacitance or a signal phase at different frequencies into volumetric flow rates for flows having single or multiple flow phases,
wherein at least one of a capacitance magnitude or signal phase at single or different frequencies is used for volume fraction estimations for flows having single or multiple phases, and
wherein a correlation between the capacitance magnitude or the signal phase at single or different frequencies from the sensor is used for phase flow velocity estimations for flows having single or multiple phases, and
wherein the multi-dimensional flow meter is further comprised of a temperature sensor adapted to correct a flow density for the mass flow rate of each flow phase.

5. The capacitance flow meter of claim 1, wherein the plates can be of circular shape.

6. The capacitance flow meter of claim 1, wherein the sensor is comprised of eight plates in two layers, and wherein a correlation of signals between the plates provides axial flow velocities, and
wherein a correlation of signals between the plates in a same plane gives cross-sectional velocities.

7. The capacitance flow meter of claim 1, wherein the sensor can be of N layers, wherein correlations between layers further from each other gives a higher velocity resolution.

8. The capacitance flow meter of claim 1, wherein slip velocities between flow phases is calculated as a difference between velocities of flow components or the flow phases.

9. The capacitance flow meter of claim 3, wherein the temperature sensor and a pressure sensor is adapted to correct for flow densities of flow phases.

10. The capacitance flow meter of claim 1, wherein the capacitance flow meter is configured to detect flow patterns and behavior by ratiometric estimation of measurements from plates or plate pairs with different geometries.

11. The capacitance flow meter of claim 1, wherein the capacitance flow meter can be applied to any combination of gases, liquids, and solids.

12. The capacitance flow meter of claim 1, wherein the non-transitory computer-readable medium can be RAM memory, CDROM or other various types of memory disks or non-transitory storage medium.

13. A capacitance flow meter comprising:
a capacitance sensor having a plurality of plates, including at least one receiver plate and at least one excite plate,
a data acquisition circuit in communication with the capacitance sensor, wherein the data acquisition circuit receives input data from the capacitance sensor including current output from the capacitance sensor,
one or more processors operationally connected to the data acquisition circuit, wherein the one or more processors receive a signal from the data acquisition circuit and wherein the one more processors are configured to extract amplitude or phase data from the signal,
a thermal sensor operationally connected to the data acquisition circuit, and
a non-transitory computer-readable medium including one or more sequences of instructions that, when executed by the one or more processors, cause the one or more processors to obtain a mass flow rate of a single-phase flow based on information received from the thermal sensor.

14. The capacitance flow meter of claim 13 wherein the capacitance flow meter is adapted to detect a flow regime of a multi-phase flow by analyzing any combination of a time series signal of volume fraction, a volume fraction range, a symmetry in the time series signal, or a frequency analysis.

15. The capacitance flow meter of claim 14, wherein the capacitance flow meter is adapted to detect the flow regime of the multi-phase flow by a comparison of signals between sets of plates of the capacitance sensor or an analysis of a flow velocity.

16. The capacitance flow meter of claim 14, wherein the non-transitory computer-readable medium includes one or more sequences of instructions that, when executed by one or more processors, cause the one or more processors to perform a spectroscopy sweep of the multi-phase flow; and
wherein the sweep is performed by exciting the plates with an excitation signal frequency sweep to record a response over a frequency sweep range.

17. The capacitance flow meter of claim 13, wherein the combination of the thermal sensor with the capacitance flow meter provides the ability to measure the mass flow rate in both single and multi-phase flow regimes.

18. The capacitance flow meter of claim 13, wherein the thermal sensor uses two thermometers along the direction of the single-phase flow,
wherein heat is injected after a first thermometer and before a second thermometer, and
wherein a difference in temperature between the first and second thermometers is used to calculate the mass flow rate of the single-phase flow.

19. The capacitance flow meter of claim 14, wherein flow regime relates to a distribution style or styles of the flow.

20. The capacitance flow meter of claim 13, wherein the non-transitory computer-readable medium includes one or more sequences of instructions that, when executed by one or more processors, cause the one or more processors to determine a mass flow rate of a multi-phase flow when signals from the thermal sensor are compensated with a volume fraction of each phase.

21. The capacitance flow meter of claim 13, wherein the thermal sensor is adapted to be wrapped around a pipe or column, placed on a spot on a surface of a conduit through which the flow is conveyed, or inserted as a probe into the flow.

22. The capacitance flow meter of claim 14, wherein symmetry in the time series signal is the difference between an average of the signal and a range of the signal and wherein the symmetry can be normalized by the average.

23. The capacitance flow meter of claim 13, wherein the heat is injected by the first thermometer or the second thermometer.

24. The capacitance flow meter of claim 1, wherein the capacitance flow meter is adapted to detect a flow regime of a multi-phase flow by analyzing any combination of a time series signal of volume fraction, a volume fraction range, a symmetry in the time series signal, or a frequency analysis.

25. The capacitance flow meter of claim 1, wherein the capacitance flow meter is adapted to detect a flow regime of the multi-phase flow by a comparison of signals between sets of plates of the capacitance sensor or an analysis of the flow velocity.
